(19) United States
(12) Patent Application Publication
(10) Pub. No.: US 2008/0254333 A1
(43) Pub. Date: Oct. 16, 2008

(54) Steam electrolytic apparatus and steam electrolytic method

(75) Inventors: Masato YOSHINO, Yokohama-shi (JP); Kentaro Matsunaga, Kita-Ku (JP); Seiji Fujiwara, Kawasaki-shi (JP); Hiroyuki Yamauchi, Yokohama-shi (JP); Shigeo Kasai, Kamakura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/100,176

(22) Filed: Apr. 9, 2008

(30) Foreign Application Priority Data
Apr. 10, 2007 (JP) 2007-102383

(51) Int. Cl. H01M 8/10

(52) U.S. Cl. 429/30; 429/15

(57) ABSTRACT

To provide a high-temperature steam electrolytic apparatus and method that steam can be used as a common gas between a hydrogen electrode and an oxygen electrode, and the steam can be electrolyzed efficiently while the electrodes of the electrochemical cell are suppressed from oxidative and reductive degradation. A steam electrolytic apparatus 10, comprising an electrochemical cell composed of an electrolyte containing a solid oxide mainly, a hydrogen electrode and an oxygen electrode; a steam supply portion 13 for supplying the electrochemical cell 11 with a gas containing steam as a main component; a hydrogen gas discharge portion 14 for discharging hydrogen generated by the hydrogen electrode by electrolysis of the steam; and an oxygen gas discharge portion 15 for discharging oxygen generated by the oxygen electrode by electrolysis of the steam, wherein the oxygen electrode contains a reduction-resistant material.

### BACKGROUND OF THE INVENTION

1. Field of the Invention

The present invention relates to a steam electrolytic apparatus which has a simple apparatus structure using the same steam as gases to be supplied to a hydrogen electrode and an oxygen electrode, has the electrodes made to have a long service life and can produce hydrogen by electrolysis of the steam with higher efficiency, and to a steam electrolytic method.

2. Description of the Related Art

A high-temperature steam electrolytic method is a method to obtain hydrogen and oxygen by electrolyzing high-temperature steam, and its operating principle is a reverse reaction of a solid oxide fuel cell (hereinafter called the SOFC).

To conduct the high-temperature steam electrolysis, in general, an electrochemical cell which composed a solid oxide electrolyte material between a hydrogen electrode and an oxygen electrode is used, and a structure to partition hydrogen and oxygen obtained by the electrolysis of steam with the electrochemical cell is necessary. Conventionally, a hydrogen electrode side atmosphere has fuel gases of steam and hydrogen as main components, while an oxygen electrode side atmosphere has nitrogen and oxygen as main components when it is assumed that a supply gas is air, and oxygen becomes the main component when the supply gas is oxygen. In such a case, gas types supplied to both electrodes are quite different, and a separate gas supply mechanism is required for them, and the structure becomes complex.

The electrochemical cell has a flat type structure, a cylindrical type structure or the like, and the hydrogen electrode side atmosphere and the oxygen electrode side atmosphere are partitioned by a fine structure of a solid oxide electrolyte configuring the electrochemical cell and a gas seal at a cell end portion to minimize a leakage of the atmosphere gases to each other. In a case where the electrochemical cell is used alone, the gas seal at the cell end portion is relatively easy, but when it is stacked in plural and used as an assembly, it is considered that the reliability of the gas seal at the cell end portion is particularly degraded.

A conventional high-temperature steam electrolytic apparatus having cylindrical cells arranged in plural (see JP-A 3-62460 (KOKAI)) is described below as an example with reference to the drawings. A schematic structure diagram of the conventional high-temperature steam electrolytic apparatus is shown in FIG. 12, and the structure of the cell and its periphery is shown in FIG. 13.

As shown in FIG. 12, a main configuration portion of a steam electrolytic apparatus 100 comprises cylindrical electrolysis cells 101, a steam supply chamber 102, a steam and generated hydrogen discharge chamber 103, a steam charging pipe 104 and an oxygen generation chamber 105.

As shown in FIG. 13, the electrochemical cell 101 has a metal cap 106 for a current lead provided at its one end and a sealing cap 107 provided at the other end to have a closed structure, such that the cell is configured to supply and discharge the fuel at the one end only. And, the cell is supported by a sealing portion with a tube plate. The current lead is configured such that the current lead portion on the hydrogen electrode side is taken out by using a tapered seal 108, the oxygen electrode side has the cell lead portion at the lower end of the cell fixed to the sealing cap 107 and introduced into the cell interior and taken out from the metal cap 106 for the current lead through a reducing atmosphere.

When configured as described above, the atmosphere gas on the hydrogen electrode side and the atmosphere gas on the oxygen electrode side each contain hydrogen and steam on the hydrogen electrode side and nitrogen and oxygen on the oxygen electrode side, so that a gas introduction portion must be divided, and the structure becomes complex. And, the gas seal portion of the hydrogen electrode side atmosphere and the oxygen electrode side atmosphere is provided at two positions of the upper and lower portions of the cell, and the gas seal portion has a sealing structure including the cell lead portion for either portion, so that it is hard to realize secure and reliable sealing. In addition, the seal life tends to become short because of use at a high-temperature, and there was an issue of extending the service life.

As a dominant means of solving the above problems, a steam electrolytic method and apparatus have been proposed as indicated in JP-A 2007-63619 (KOKAI) that for steam electrolysis of conducting the electrolysis of steam and generation of hydrogen by using an electrochemical cell which has as main component elements an electrolyte having a solid oxide as a main material, a hydrogen electrode and an oxygen electrode, a steam electrolytic method and apparatus are based on the fact that gases supplied to the hydrogen electrode and the oxygen electrode each contain steam as a main component and characterized by supply conditions, flow conditions and the like, and an inert gas other than hydrogen and oxygen or a gas containing steam as a main component is supplied to the neighborhood of a sealing part which divides a hydrogen electrode atmosphere and an oxygen electrode atmosphere.

Thus, it has become possible to obtain a high-temperature steam electrolytic method and apparatus that the apparatus structure is simplified, an influence of a gas leak caused between the hydrogen electrode side atmosphere and the oxygen electrode side atmosphere is reduced, and a moderate, simple and safe operation can be conducted as much as possible.

### BRIEF SUMMARY OF THE INVENTION

As a hydrogen electrode material, a material such as Ni—YSZ (nickel-yttria-stabilized zirconia), Ni—SDC (nickel-ceria) or the like is generally used, but such materials are used in a reducing atmosphere, and as an oxygen electrode material, a composite oxide such as LSC (lanthanum strontium cobaltite), LSM (lanthanum strontium manganite) or the like is generally used. But when such a composite oxide material is used in an oxygen atmosphere of a low concentration, the structure is changed by desorption of the oxygen configuring the crystal structure, and when the gas has steam as a main component, it might be hard to keep the properties.

Accordingly, the present invention provides a high-temperature steam electrolytic apparatus and method capable of electrolyzing steam efficiently while keeping the advantages of the steam electrolytic apparatus and method of the invention using steam as a gas which is commonly used for the hydrogen electrode and the oxygen electrode and also suppressing oxidative and reductive degradation of the electrodes of the electrochemical cell.

As a result of devoted studies, the present inventors have found that the performance and durability of an electrochemical cell can be improved by using as the electrode material an oxidation-resistant material for a hydrogen electrode and/or a reduction-resistant material for an oxygen electrode, and completed the present invention.

Specifically, a steam electrolytic apparatus according to an embodiment of the present invention comprises an electrochemical cell composed of an electrolyte containing a solid oxide mainly, a hydrogen electrode and an oxygen electrode; a steam supply portion for supplying the electrochemical cell with a gas containing steam as a main component; a hydrogen gas discharge portion for discharging hydrogen generated at the hydrogen electrode by electrolysis of the steam; and an oxygen gas discharge portion for discharging oxygen generated at the oxygen electrode by electrolysis of the steam, wherein the oxygen electrode contains a reduction-resistant material.

A steam electrolytic apparatus according to another embodiment of the present invention comprises an electrochemical cell composed of an electrolyte containing a solid oxide mainly, a hydrogen electrode and an oxygen electrode; a steam supply portion for supplying the electrochemical cell with a gas containing steam as a main component; a hydrogen gas discharge portion for discharging hydrogen generated at the hydrogen electrode by electrolysis of the steam; and an oxygen gas discharge portion for discharging oxygen generated at the oxygen electrode by electrolysis of the steam, wherein the hydrogen electrode contains an oxidation-resistant material.

A steam electrolytic apparatus according to still another embodiment of the present invention comprises an electrochemical cell composed of an electrolyte containing a solid oxide mainly, a hydrogen electrode and an oxygen electrode; a steam supply portion for supplying the electrochemical cell with a gas containing steam as a main component; a hydrogen gas discharge portion for discharging hydrogen generated at the hydrogen electrode by electrolysis of the steam; and an oxygen gas discharge portion for discharging oxygen generated at the oxygen electrode by electrolysis of the steam, wherein the hydrogen electrode contains an oxidation-resistant material, and the oxygen electrode contains a reduction-resistant material.

A steam electrolytic method according to an embodiment of the present invention comprises a gas supply step for supplying a raw material gas; an electrolysis step for generating a hydrogen gas and an oxygen gas by contacting the supplied raw material gas to an electrochemical cell which is composed of an electrolyte containing a solid oxide mainly, a hydrogen electrode and an oxygen electrode to electrolyze steam contained in the raw material gas; and a gas discharge step for separately discharging the hydrogen gas and the oxygen gas without causing a leakage of them, wherein the hydrogen electrode contains an oxidation-resistant material, and the oxygen electrode contains a reduction-resistant material.

According to the steam electrolytic apparatus and method of the present invention, a simple apparatus structure can be configured, and steam can be electrolyzed efficiently while suppressing oxidative and reductive degradation of the electrodes of the electrochemical cell.

### BRIEF DESCRIPTION OF THE DRAWINGS

FIG. 1 is a perspective view showing an outline structure of a steam electrolytic apparatus using a flat electrochemical cell.

FIG. 2 is a side sectional view of the steam electrolytic apparatus shown in FIG. 1.

FIG. 3 is a perspective view showing an outline structure of a steam electrolytic apparatus using a cylindrical electrochemical cell.

FIG. 4 is a side sectional view of the steam electrolytic apparatus shown in FIG. 3.

FIG. 5 is a side sectional view of a steam electrolytic apparatus using a one end-closed cylindrical electrochemical cell.

FIG. 6 is a side sectional view of a steam electrolytic apparatus that a hydrogen electrode side and an oxygen electrode side have an opposite gas flowing direction.

FIG. 7 is a side sectional view showing an outline structure of the steam electrolytic apparatus according to a second embodiment.

FIG. 8 is a side sectional view showing an outline structure of the steam electrolytic apparatus according to a third embodiment.

FIG. 9 is a side sectional view showing an outline structure of the steam electrolytic apparatus according to a fourth embodiment.

FIG. 10 is a side sectional view showing an outline structure of the steam electrolytic apparatus according to a fifth embodiment.

FIG. 11 is a side sectional view showing an outline structure of the steam electrolytic apparatus according to a sixth embodiment.

FIG. 12 is a schematic structure diagram of a conventional high-temperature steam electrolytic apparatus.

FIG. 13 is a structure diagram of a conventional cell and its periphery.

### DETAILED DESCRIPTION OF THE INVENTION

A high-temperature steam electrolytic apparatus and method according to the present invention is described below with reference to the drawings.

### First Embodiment

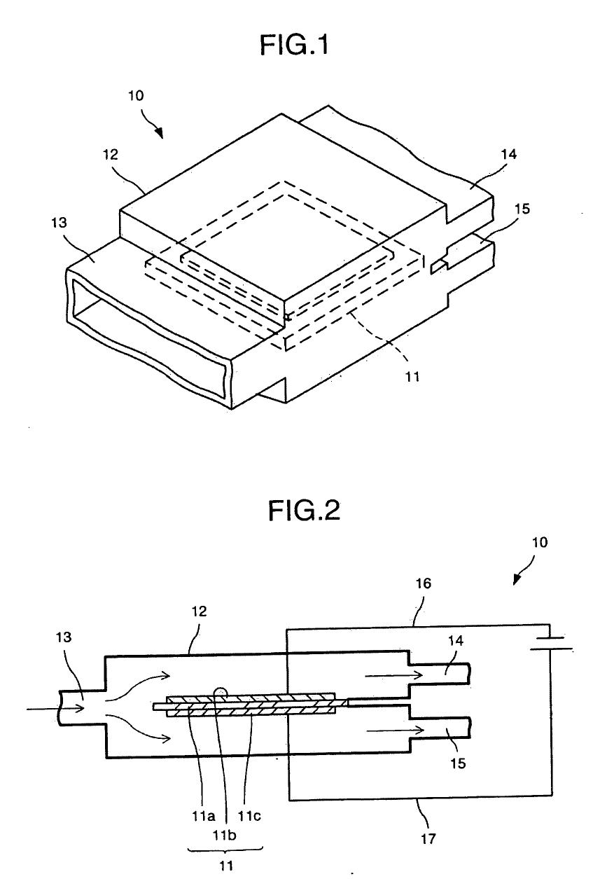

A first embodiment of the high-temperature steam electrolytic apparatus and method according to the present invention is described with reference to FIGS. 1 to 6. FIG. 1 is a perspective view (for the inner structure, only the electrochemical cell within the casing is indicated by a broken line) showing an outline structure of the steam electrolytic apparatus with a flat electrochemical cell applied solely, and FIG. 2 is its side sectional view.

As shown in FIG. 1 and FIG. 2, a steam electrolytic apparatus 10 according to the first embodiment is mainly comprised of an electrochemical cell 11, a casing 12 for containing the electrochemical cell 11, a steam supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16 and an oxygen electrode side current lead portion 17.

The electrochemical cell used in the present invention is not limited to a particular one if it is configured with an electrolyte mainly containing a solid oxide sandwiched between the hydrogen electrode and the oxygen electrode. For example, as shown in FIG. 2, a flat electrochemical cell 11 which has a hydrogen electrode 11b and an oxygen electrode 11c provided to sandwich therebetween an electrolyte 11a mainly containing a flat solid oxide as a substrate is an example.

The electrolyte used here mainly contains a solid oxide, and there are, for example, a stabilized zirconia based electrolyte which is a solid solution of Y₂O₃, Sc₂O₃, Nd₂O₃, Sm₂O₃, Gd₂O₃, Yb₂O₃ or the like with ZrO₂, a ceria based electrolyte which is a solid solution of Sm₂O₃, Gd₂O₃, Y₂O₃ or the like with CeO₂, a lanthanum gallate based electrolyte which has LaGaO₃ such as LaSrGaMgO₃ or the like as a parent body with elements partly substituted, a proton conductor such as an electrolyte or the like which has SrCeO₃, BaCeO₃ or them used as a parent body with elements partly substituted, a bismuth oxide based electrolyte which is a solid solution of Y₂O₃, Nd₂O₅, WO₃, Gd₂O₃ or the like with Bi₂O₃, and a pyrochlore type oxide based electrolyte such as La₂Zr₂O₇, La₂Zr₂O₇, Sm₂Zr₂O₇, Gd₂Zr₂O₇ or the like.

In addition, the hydrogen electrode 11b used here is formed to contain an oxidation-resistant material therein and is satisfactory if its functions such as electric conductivity, catalyst activity or the like required for the electrochemical reaction are not lost by oxidation. The oxidation-resistant material is contained into the electrode to make it possible to decrease the oxidative degradation of the electrode even if a gas containing steam as a main component with a reducing atmosphere decreased to a level lower than the conventional gas is used for the supply gas.

In this case, the oxidation-resistant material is not limited to any particular type if its material quality is superior in oxidation resistance to the conventionally used material quality (Ni—YSZ, Ni—SDC or the like) of the hydrogen electrode. For example, it is a noble metal such as Pt, Ru, Pd, Rh or the like, and the hydrogen electrode may be formed by using such a noble metal solely, and also an alloy of such noble metals, or cermet (a mixture of ceramic and metal) which has a noble metal mixed with porous ceramic such as YSZ (yttria-stabilized zirconia), ScSZ (scandia-stabilized zirconia), SDC (samaria-substituted ceria), GDC (gadolinium-substituted ceria), LDC (lanthanum-substituted ceria) or the like. In a case where the cermet is used, it is desirable that the mixing ratio of the noble metal is 0.1 to 2 mass %.

Meanwhile, the oxygen electrode 11c used here is formed to contain the reduction-resistant material and it is appropriate if its functions such as electric conductivity, catalyst activity or the like required for the electrochemical reaction are not lost by reduction. Here, since the electrode contains the reduction-resistant material, the reduction degradation of the electrode can be reduced even if steam which has an oxidizing atmosphere decreased to a level lower than the conventional gas is used for the supply gas.

In this case, the reduction-resistant material is not limited to a particular type if its quality is superior in reduction resistance to the conventionally used material quality (LSM, LSC) of the oxygen electrode, and it is, for example, a noble metal such as Pt, Ru, Pd, Rh or the like, and the oxygen electrode may be formed by using such a noble metal solely or an alloy of such noble metals.

In this embodiment, the electrochemical cell 11 configured as described above is housed in the casing 12, and the casing 12 is configured to guide a gas containing steam as a main component which is a raw material to the hydrogen electrode 11b and the oxygen electrode 11c of the electrochemical cell 11, to electrolyze the steam to generate hydrogen gas and oxygen gas and to discharge them. In other words, the casing 12 has the steam supply portion 13 for supplying the gas containing steam as the main component, the hydrogen gas discharge portion 14 for discharging the mixed gas of the hydrogen gas generated at the hydrogen electrode side and the raw material gas, and the oxygen gas discharge portion 15 for discharging the mixed gas of the oxygen gas generated at the oxygen electrode side and the raw material gas, and the end portion of the electrochemical cell is sealed to prevent the hydrogen gas and the oxygen gas from leaking and mixing.

The sealing method of the electrochemical cell end portion is not limited to a particular one if the gases of the hydrogen electrode side and the oxygen electrode side can be prevented from leaking, and there is a sealing method using, for example, a glass material, a ceramic material or the like to bond the electrochemical cell 11 and the casing 12.

In addition, in a case where, for example, the flat electrochemical cell of FIG. 1 is used, a supporting and fixing portion for supporting and fixing the electrochemical cell 11 is formed by forming grooves mechanically in the casing 12. Thus, simple sealing can be made by merely supporting and fixing the electrochemical cell 11. Besides, sealing performance can be improved by reinforcing the bonding by the ceramic material or the glass material.

The electrochemical cell 11 has the hydrogen electrode side current lead portion 16 connected to the hydrogen electrode and the oxygen electrode side current lead portion 17 connected to the oxygen electrode, so that voltage can be applied to the oxygen electrode and the hydrogen electrode by such lead portions.

The steam electrolytic apparatus 10 configured as described above according to this embodiment can use the same supply portion 13 for the gas supplied to the hydrogen electrode 11b side and the oxygen electrode 11c side because the same gas containing steam as the main component is introduced. Therefore, a device and a mechanism for introducing a quite different gas to both the electrodes in such a manner as a conventional way that, for example, steam and a reducing gas are supplied to the hydrogen electrode side and air is supplied to the oxygen electrode side are not required, and a steam electrolytic apparatus having a simple apparatus structure can be provided. Since the same supply portion is used and both the electrodes have the same supply pressure, a gas leak at the cell end portion can be minimized.

This embodiment shows a flat electrochemical cell, but the present invention does not restrict the electrochemical cell to a particular type, and as the electrochemical cell, a flat type, a cylindrical type, a one end-closed cylindrical type, a honeycomb type, a pleated type, a corrugated type or the like can also be used. And, this cell may be a single body or an assembly of plural cells, and its size is not limited to a particular one if the electrolysis can be conducted adequately.

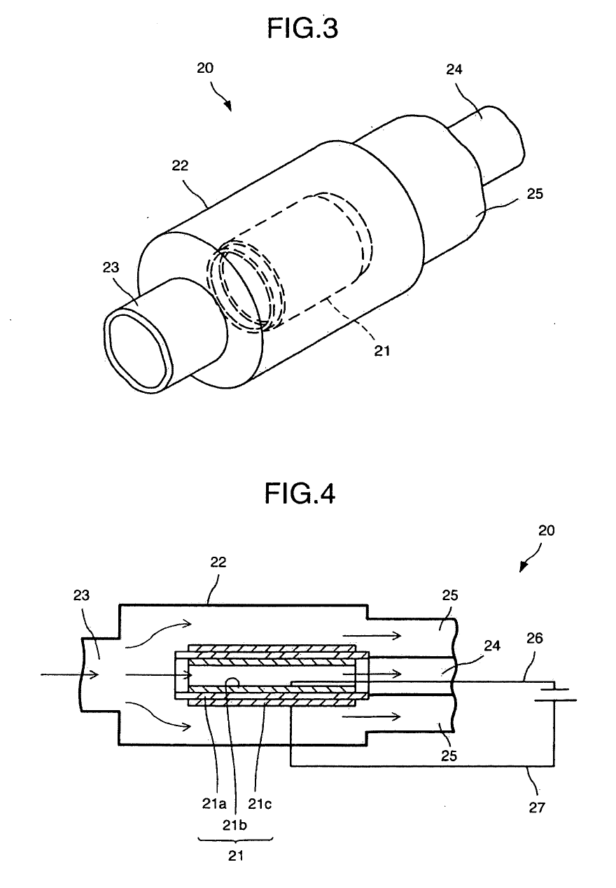

As an example of a steam electrolytic apparatus using a cylindrical electrochemical cell, FIG. 3 is a perspective view (for the inner structure, only the electrochemical cell within the casing is indicated by a broken line) showing an outline structure of the steam electrolytic apparatus using the cylindrical electrochemical cell and FIG. 4 shows its side sectional view. This steam electrolytic apparatus 20 is mainly comprised of an electrochemical cell 21, a casing 22 for containing the electrochemical cell 21, a steam supply portion 23 for supplying a gas containing steam as a main component, a hydrogen gas discharge portion 24 for discharging the gas of a hydrogen electrode side atmosphere, an oxygen gas discharge portion 25 for discharging the gas of an oxygen electrode side atmosphere, a hydrogen electrode side current lead portion 26, and an oxygen electrode side current lead portion 27. The cylindrical electrochemical cell 21 is configured to have a cylindrical electrolyte 21a as the substrate and to dispose a hydrogen electrode 21b on its inside and an oxygen electrode 21c on its outside.

In a case where the cylindrical electrochemical cell 21 of FIG. 3 and FIG. 4 is used, the end portion of the cell is supported by fixing to the casing 22 to seal the cell, but the supporting and fixing position is not particularly limited. For example, the cell can also be sealed by extending the substrate portion of the cell and supporting by fixing to the casing 22 at a middle part of the cell. When the hydrogen gas discharge portion 24 for discharging the gas of the hydrogen electrode side atmosphere is separated from the high-temperature reaction portion, it becomes possible to separate the sealing portion from the reaction portion to have a low temperature condition, so that choices of sealing materials and methods which could not be used in the high-temperature environment are increased, and the sealing performance can be improved. Thus, a gas leak from one atmosphere to the other atmosphere of the hydrogen electrode and the oxygen electrode can be reduced easily and effectively.

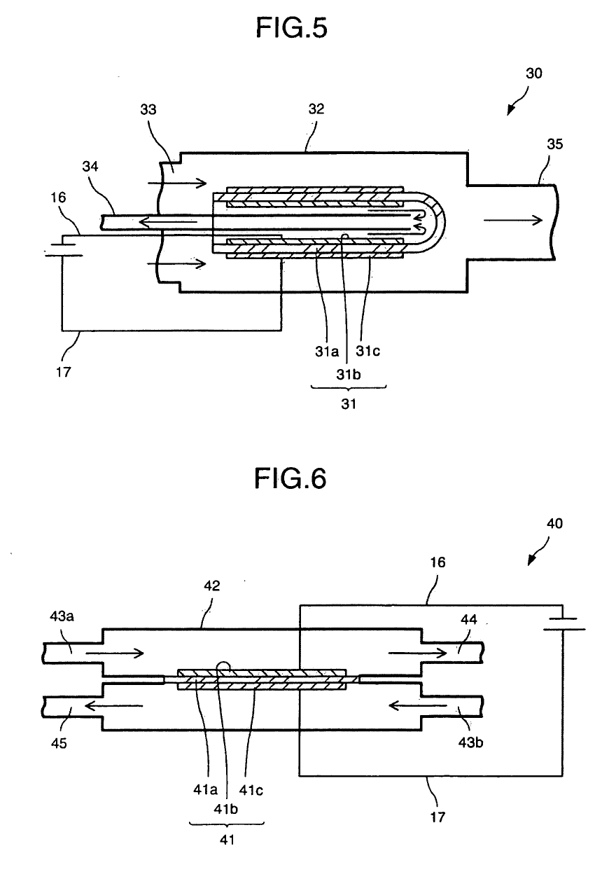

In addition, the one end-closed cylindrical electrochemical cell has a shape that one end of the cylindrical type is closed and the other end only is open, and a side sectional view of the steam electrolytic apparatus using it is shown in FIG. 5. A steam electrolytic apparatus 30 applying the one end-closed cylindrical electrochemical cell is mainly comprised of an electrochemical cell 31, a casing 32 for housing the electrochemical cell 31, a steam supply portion 33 for supplying a gas containing steam as a main component, a hydrogen gas discharge portion 34 for discharging the gas of the hydrogen electrode side atmosphere, an oxygen gas discharge portion 35 for discharging the gas of the oxygen electrode side atmosphere, a hydrogen electrode side current lead portion 36, and an oxygen electrode side current lead portion 37.

Here, the supply conditions of the gas which had steam as the main component to be supplied to the hydrogen electrode and the oxygen electrode, a steam supply flow rate, a supply flow velocity and the like, were described as the same in this embodiment. But the supply conditions are not restricted to be the same, so that may be different. In a case where the supply conditions of the gas containing steam as the main component to be supplied to the hydrogen electrode and the oxygen electrode are different, a mechanism of adjusting the supply conditions may be incorporated therein to adjust the supply flow rate, the supply flow velocity and the like. For example, it may be configured to provide a flow rate adjusting valve, to adjust a piping diameter, or the like at the gas discharge portion of each of the hydrogen electrode and the oxygen electrode, and the mechanism capable of adjusting the supply conditions is not limited to a particular method, mechanism or the like.

According to the embodiment configured as described above, the flowing direction of the gas supplied to the hydrogen electrode and the oxygen electrode is not limited to a particular one, and the gases supplied to the hydrogen electrode and the oxygen electrode may be flown in opposite directions, orthogonal directions or the like.

For example, an example of a structure to operate with gases flown in opposite directions to supply to the hydrogen electrode and the oxygen electrode is shown in FIG. 6. FIG. 6 shows an application of the flat electrochemical cell solely. In this case, a hydrogen electrode 41b side has a high hydrogen concentration atmosphere from a gas supply portion 43a side to a gas discharge portion 44 side. Meanwhile, an oxygen electrode 41c side has a gas flow direction opposite to that at the hydrogen electrode side. In other words, the gas discharge portion 44 side which is at the hydrogen electrode side becomes a gas supply portion 43b at the oxygen electrode side. Thus, the hydrogen electrode side has a high hydrogen concentration atmosphere, while the oxygen electrode side has a low oxygen concentration atmosphere. Therefore, even if a very small volume of hydrogen leaks, a combustion reaction can be suppressed to minimum because oxygen is low in volume, and the same effect can be obtained even if a very small volume of oxygen leaks to the hydrogen electrode side.

According to this embodiment, a simple apparatus structure can be formed, and the oxidation of the hydrogen electrode and the reduction of the oxygen electrode can be suppressed, and the electrodes can be made to have a long service life. In addition, since the apparatus structure is simple, it is also easy to reduce an influence due to the gas leak caused between the hydrogen electrode side atmosphere and the hydrogen electrode side atmosphere. Therefore, the steam electrolytic apparatus and method of the embodiment can electrolyze steam with high efficiency.

### Second Embodiment

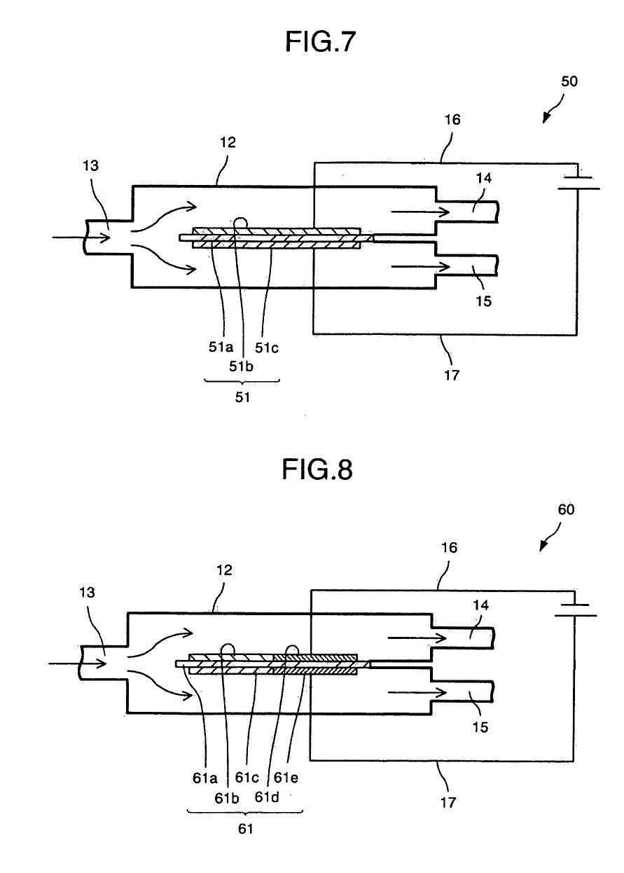

A second embodiment of the high-temperature steam electrolytic apparatus and method according to the present invention is described with reference to FIG. 7. Component parts corresponding to those of the first embodiment are denoted by common reference numerals, and duplicate descriptions will be omitted. FIG. 7 shows a side sectional view of an outline structure with a flat electrochemical cell applied solely.

As shown in FIG. 7, a steam electrolytic apparatus 50 according to the second embodiment is mainly comprised of an electrochemical cell 51, a casing 12 for housing the electrochemical cell, a steam supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16, and an oxygen electrode side current lead portion 17.

The electrochemical cell 51 shown here is a flat type similar to that of the first embodiment but not limited to it as in the first embodiment. And, the steam electrolytic apparatus 50 according to the second embodiment has the same structure as in the first embodiment excepting the electrochemical cell 51. Only differences are described below.

The electrochemical cell 51 is same as in the first embodiment on the point that it is a flat electrochemical cell having an electrolyte 51a mainly containing a flat solid oxide as a substrate and a hydrogen electrode 51b and an oxygen electrode 51c provided to sandwich it therebetween. The hydrogen electrode and the oxygen electrode of this embodiment are produced with an oxidation-resistant material or a reduction-resistant material added to an electrode material. Specifically, the hydrogen electrode 51b is formed by adding another electrode material to the oxidation-resistant material, and the oxygen electrode 51c is formed by adding another electrode material to the reduction-resistant material.

In the embodiment configured as described above, the hydrogen electrode 51b side atmosphere is a gas which has, as a main component, steam with a reducing atmosphere decreased to a level lower than a conventional gas, so that the electrode material is partially oxidized and the electrochemical reaction activity becomes low on the surface of electrode material particles within the hydrogen electrode layer, but hydrogen is sequentially generated by the electrolytic reaction to increase the reducing atmosphere. Thus, when the reducing atmosphere is increased, there is a mixed or dispersed oxidation-resistant material in the neighborhood because of the addition, the oxidized electrode material is reduced again by the hydrogen generated by the steam electrolytic reaction to resume the electrochemical reaction activity, and the steam electrolytic reaction can be conducted effectively. Therefore, it becomes possible to reduce the oxidation degradation of the hydrogen electrode and to keep the electrolytic property.

To produce the hydrogen electrode 51b, the electrode material to which the oxidation-resistant material is added is used. The addition here means mixing or dispersing, the mixing means mechanical mixing of a subject powder body, and the dispersion means impregnation of a liquid containing the oxidation-resistant material to the formed electrode material. The electrode material to which the oxidation-resistant material is added is formed into a desired shape and sintered. Thus, the electrode for the hydrogen electrode can be produced.

Here, the electrode materials for the hydrogen electrode include ceramics such as YSZ, ScSZ, SDC, GDC, LDC or the like, and the oxidation-resistant materials include, for example, noble metal materials such as Pt, Ru, Pd, Rh or the like.

The addition ratio is not particularly limited, but it is desirably an amount containing an oxidation-resistant material of 0.1 to 2 mass % in view of the effective decrease of oxidation degradation. And, it may be determined to have an inclined configuration that the composition ratio of the oxidation-resistant material is increased on the side of the steam supply portion containing steam, and the composition ratio of the oxidation-resistant material is gradually decreased toward the gas discharge portion side.

Meanwhile, the oxygen electrode 51c side has as a main component a gas containing steam with an oxidizing atmosphere decreased to a level lower than a conventional gas, so that the electrode material is partially reduced and the electrochemical reaction activity becomes low on the surfaces of electrode material particles within the oxygen electrode layer. Oxide ions are regenerated to oxygen by the electrolytic reaction, that is, oxygen is sequentially generated by the electrolytic reaction, and the oxidizing atmosphere is increased. Then, there is the added reduction-resistant material in the neighborhood, the reduced electrode material is reoxidized with the oxygen generated by the oxygen regeneration reaction, and the electrochemical reaction activity is resumed. Thus, the steam electrolytic reaction can be conducted effectively. Therefore, it becomes possible to decrease the reduction degradation of the oxygen electrode and to keep the electrolytic property.

To produce the oxygen electrode 51c, the electrode material to which the reduction-resistant material is added is used. The addition here means mixing or dispersing, the mixing means mechanical mixing of respective subject powder bodies, and the dispersion means impregnation of a liquid containing the reduction-resistant material to the formed electrode material. Thus, the electrode material to which the reduction-resistant material is added is formed into a desired shape, thereby enabling to produce the electrode for the oxygen electrode.

Here, the electrode materials for the oxygen electrode include LSM, LSC or the like, and the reduction-resistant materials include, for example, noble metal materials such as Pt, Ru, Pd, Rh or the like.

The addition ratio is not particularly limited, but it is desirably an amount to contain a reduction-resistant material of 0.1 to 2 mass % in view of the effective reduction of reduction degradation. And, it may be determined to have an inclined configuration that the composition ratio of the reduction-resistant material is increased on the side of the steam supply portion containing steam, and the composition ratio of the reduction-resistant material is gradually decreased toward the gas discharge portion side.

According to this embodiment, a simple apparatus structure can be formed, oxidation or reduction of the hydrogen electrode and the oxygen electrode is suppressed efficiently, and the electrodes can be made to have a long service life. In addition, since the apparatus structure is simple, it is also easy to reduce an influence due to the gas leak caused between the hydrogen electrode side atmosphere and the hydrogen electrode side atmosphere. Therefore, the steam electrolytic apparatus and method of the embodiment can electrolyze steam with high efficiency.

### Third Embodiment

A third embodiment of the high-temperature steam electrolytic apparatus and method according to the present invention is described below with reference to FIG. 8. Component parts corresponding to those of the first embodiment are denoted by common reference numerals, and duplicate descriptions will be omitted. FIG. 8 shows an embodiment that the flat electrochemical cell is applied solely.

As shown in FIG. 8, a steam electrolytic apparatus 60 according to the third embodiment is mainly comprised of an electrochemical cell 61, a casing 12 for housing the electrochemical cell, a supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16, and an oxygen electrode side current lead portion 17.

The electrochemical cell 61 shown here is a flat type similar to that of the first embodiment but not limited to it as in the first embodiment. And, the steam electrolytic apparatus 60 according to the third embodiment has the same structure as in the first embodiment excepting the electrochemical cell 61. Only differences are described below.

The electrochemical cell 61 is same as in the first embodiment on the point that it is a flat electrochemical cell having an electrolyte 61a mainly containing a flat solid oxide as a substrate, and a hydrogen electrode and an oxygen electrode provided to sandwich it therebetween. According to this embodiment, the hydrogen electrode is comprised of hydrogen electrodes 61b and 61d, and the oxygen electrode is comprised of oxygen electrodes 61c and 61e, and the gas supply portion side and the gas discharge portion side are configured of the electrodes of a different material.

In the embodiment configured as described above, the hydrogen electrode side atmosphere is a gas which has, as a main component, steam with a reducing atmosphere decreased to a level lower than a conventional gas, and it is prominent on the steam supply portion 13 side. And, steam is electrolyzed to generate hydrogen toward the hydrogen gas discharge portion side, so that the reducing atmosphere is increased. Therefore, the electrode of the hydrogen electrode 61b on the steam supply portion side is formed of an oxidation-resistant material, so that it becomes possible to reduce the oxidation degradation of the electrode and to keep the electrolytic property.

In this case, the oxidation-resistant material is not limited to a particular type if its material quality is superior in reduction resistance to the material (Ni—YSZ, Ni—SDC or the like) of the conventionally used hydrogen electrode, and it is, for example, a noble metal such as Pt, Ru, Pd, Rh or the like. And the hydrogen electrode may be formed by using such a noble metal solely, an alloy of such noble metals, or a cermet (a mixture of ceramic and metal) having porous ceramic such as YSZ, ScSZ, SDC, GDC, LDC or the like mixed with a noble metal. In a case where a cermet is used, it is desirable that the mixing ratio of the noble metal is 0.1 to 2 mass %.

The hydrogen electrode 61d disposed on the hydrogen gas discharge portion side is not limited to a particular material quality and, for example, Ni—YSZ or Ni—SDC may be used. And, a construction ratio of the hydrogen electrode 61b disposed on the steam-containing gas supply portion side to the hydrogen electrode 61d disposed on the hydrogen gas discharge portion side is not particularly limited and may be determined appropriately depending on a situation such as an amount of electric current, a coefficient of use of steam, or the like.

In this embodiment, the hydrogen electrode is formed of two different materials, and the steam supply portion 13 side is determined to contain an oxidation-resistant material but may be formed of three or more different materials. In such a case, the steam supply portion 13 side is formed of the material having the best oxidation resistance among the used electrode materials, and the materials may be bonded and disposed so that the oxidation resistance decreases stepwisely toward the hydrogen gas discharge portion 14 side.

Meanwhile, the oxygen electrode side is a gas which has, as a main component, steam having a reducing atmosphere decreased to a level lower than the conventional gas, and it is prominent on the steam supply portion 13 side. And, the oxide ions generated by the electrolysis of the steam on the hydrogen electrode side are moved toward the oxygen gas discharge portion 15 side through the electrolyte to regenerate oxygen on the oxygen electrode side, so that the oxidizing atmosphere is increased. Thus, the electrode of the oxygen electrode 61c on the gas supply portion side is formed of a reduction-resistant material, so that it becomes possible to reduce the reduction degradation of the electrode and to keep the electrolytic property.

In this case, the reduction-resistant material is not limited to a particular type if it is formed to contain the reduction-resistant material and functions required for the electrochemical reaction, such as electric conductivity, catalyst activity or the like, are not lost by the reduction. In this case, the reduction-resistant material is not limited to a particular type if its material quality is superior in reduction resistance to the conventionally used material quality (LSM, LSC) of the oxygen electrode, and it is, for example, a noble metal such as Pt, Ru, Pd, Rh or the like, and the oxygen electrode may be formed by using such a noble metal solely or an alloy of such noble metals.

The oxygen electrode 61e disposed on the side of the oxygen gas discharge portion is not limited to a particular material quality and, for example, LSM, LSC or the like may be used.

A construction ratio of the oxygen electrode 61c disposed on the steam-containing gas supply portion side to the oxygen electrode 61e disposed on the oxygen gas discharge portion side is not particularly limited and may be determined appropriately depending on a situation such as an amount of electric current, a coefficient of use of steam, or the like.

In this embodiment, the oxygen electrode is formed of two different materials, and the steam supply portion 13 side is determined to contain a reduction-resistant material, but the oxygen electrode may be formed of three or more different materials. In such a case, the steam supply portion 13 side is formed of the material having the best reduction resistance among the used electrode materials, and the materials may be bonded and disposed so that the reduction resistance decreases stepwisely toward the oxygen gas discharge portion 15 side.

According to this embodiment, a simple apparatus structure can be formed, oxidation or reduction of the hydrogen electrode and the oxygen electrode is suppressed efficiently, and the electrodes can be made to have a long service life. In addition, since the apparatus structure is simple, it is also easy to reduce an influence due to the gas leak caused between the hydrogen electrode side atmosphere and the hydrogen electrode side atmosphere. Therefore, the steam electrolytic apparatus and method of the embodiment can electrolyze steam with high efficiency.

### Fourth Embodiment

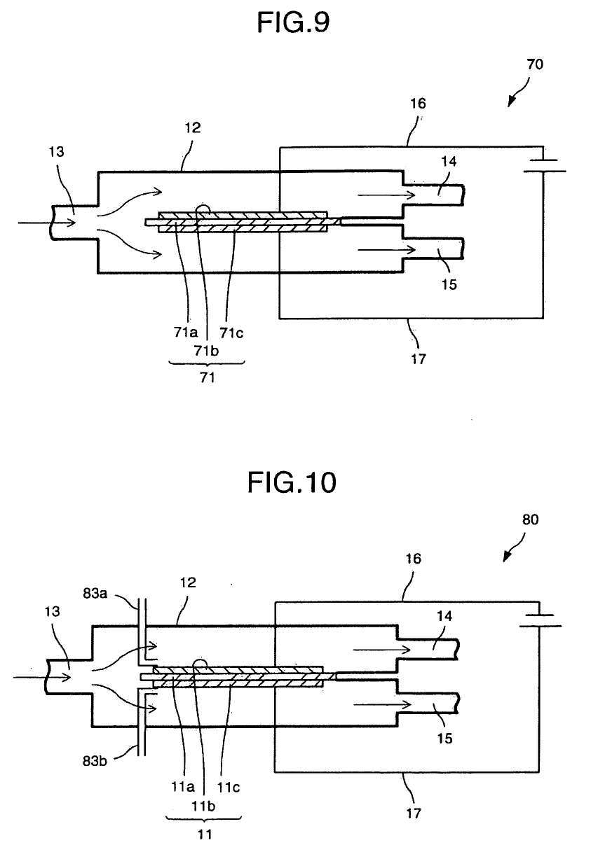

A fourth embodiment of the high-temperature steam electrolytic apparatus and method according to the present invention is described with reference to FIG. 9. Component parts corresponding to those of the first embodiment are denoted by common reference numerals, and duplicate descriptions will be omitted. FIG. 9 shows the embodiment that the flat electrochemical cell is solely applied.

As shown in FIG. 9, a steam electrolytic apparatus 70 according to the fourth embodiment is mainly comprised of an electrochemical cell 71, a casing 12 for housing the electrochemical cell, a supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16, and an oxygen electrode side current lead portion 17.

The electrochemical cell 71 is same as in the first embodiment on the point that it is a flat electrochemical cell having an electrolyte 71a mainly containing a flat solid oxide as a substrate, and a hydrogen electrode 71b and an oxygen electrode 71c provided to sandwich it therebetween. According to this embodiment, the hydrogen electrode and the oxygen electrode each are configured so that a contained ratio of an oxidation-resistant material or a reduction-resistant material decreases from the gas supply portion side toward the gas discharge portion side.

Specifically, the hydrogen electrode 71b is formed to slantly decrease a concentration of the oxidation-resistant material from the steam supply portion 13 side toward the hydrogen gas discharge portion 14 side, and the oxygen electrode 71c is formed to slantly decrease a concentration containing the reduction-resistant material from the steam supply portion 13 side toward the oxygen gas discharge portion 15 side.

In the embodiment configured as described above, the hydrogen electrode 71b side atmosphere is a gas which has, as a main component, steam having a reducing atmosphere decreased to a level lower than the conventional gas, and it is prominent on the steam supply portion 13 side. And, steam is electrolyzed to generate hydrogen toward the hydrogen gas discharge portion side, so that the reducing atmosphere is increased. Therefore, the hydrogen electrode 71b is an electrode that a composition ratio of the oxidation-resistant material of the gas supply portion side is increased and has a structure that the concentration is inclined to gradually decrease the composition ratio of the oxidation-resistant material toward the discharge portion side, so that it becomes possible to reduce the oxidation degradation of the electrode material and to keep the electrolytic property.

In this case, the oxidation-resistant material is not limited to a particular type if its material quality is superior in oxidation resistance to the conventionally used material quality (Ni—YSZ, Ni—SDC, or the like) of the hydrogen electrode, and it is, for example, a noble metal such as Pt, Ru, Pd, Rh or the like and may be formed by using such a noble metal solely, an alloy of such noble metals or a cermet (a mixture of ceramic and metal) having porous ceramic such as YSZ, ScSZ, SDC, GDC, LDC or the like mixed with a noble metal.

Meanwhile, the oxygen electrode side is a gas which has, as a main component, steam having a reducing atmosphere decreased to a level lower than the conventional gas, and it is prominent on the steam supply portion 13 side. And, the oxide ions generated by the electrolysis of the steam on the hydrogen electrode side are moved toward the oxygen gas discharge portion 15 side through the electrolyte, and oxygen is regenerated on the oxygen electrode side, so that the oxidizing atmosphere is increased. Thus, the oxygen electrode 71c is an electrode that a composition ratio of the reduction-resistant material of the gas supply portion side is increased and has a structure that the concentration is inclined to gradually decrease the composition ratio of the reduction-resistant material toward the discharge portion side, so that it becomes possible to reduce the reduction degradation of the electrode material and to keep the electrolytic property.

In this case, the reduction-resistant material is not limited to a particular type if it is formed to contain a reduction-resistant material, and functions required for the electrochemical reaction, such as electric conductivity, catalyst activity or the like, are not lost by the reduction. In this case, the reduction-resistant material is not limited to a particular type if its material quality is superior in reduction resistance to the conventionally used material quality (LSM, LSC) of the oxygen electrode, and it is, for example, a noble metal such as Pt, Ru, Pd, Rh or the like, and the oxygen electrode may be formed by using such a noble metal solely or an alloy of such noble metals.

According to this embodiment, a simple apparatus structure can be formed, and oxidation or reduction of the hydrogen electrode and the oxygen electrode is suppressed efficiently, and the electrodes can be made to have a long service life. In addition, since the apparatus structure is simple, it is also easy to reduce an influence due to the gas leak caused between the hydrogen electrode side atmosphere and the hydrogen electrode side atmosphere. Therefore, the steam electrolytic apparatus and method of the embodiment can electrolyze steam with high efficiency.

### Fifth Embodiment

A fifth embodiment of the high-temperature steam electrolytic apparatus and method according to the present invention is described below with reference to FIG. 10. Component parts corresponding to those of the first embodiment are denoted by common reference numerals, and duplicate descriptions will be omitted. FIG. 10 shows the embodiment that the flat electrochemical cell is applied solely.

As shown in FIG. 10, a steam electrolytic apparatus 80 according to the fifth embodiment is mainly comprised of an electrochemical cell 11, a casing 12 for housing the electrochemical cell, a supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16, an oxygen electrode side current lead portion 17, a reducing gas supply portion 83a for supplying a reducing gas to the hydrogen electrode side atmosphere, and an oxidizing gas supply portion 83b for supplying an oxidizing gas to the oxygen electrode side atmosphere.

This electrochemical cell 11 of this embodiment is same as in the first embodiment and has the same structure as in the first embodiment except that the steam supply portion 13 side of the electrochemical cell 11 is provided with the reducing gas supply portion 83a and the oxidizing gas supply portion 83b.

Specifically, the reducing gas supply portion 83a for supplying the reducing gas is provided on the hydrogen electrode 11b side of the electrochemical cell 11 to enable to supply the reducing gas so to have a reducing atmosphere on the surface of the hydrogen electrode 11b in the steam supply portion side. And, the oxygen electrode 11c side is provided with the oxidizing gas supply portion 83b for supplying the oxidizing gas so that the oxidizing gas can be supplied to have the oxidizing atmosphere on the surface of the oxygen electrode 11c in the steam supply portion side.

A reducing atmosphere on the hydrogen electrode 11b side of the electrochemical cell 11 is increased by supplying the reducing gas to the supply gas containing steam as the main component, so that it becomes possible to decrease the oxidation degradation of the electrode material and to keep the electrolytic property. Hydrogen can be used as the reducing gas, but its type is not particularly limited if the reducing atmosphere can be increased.

It is desirable that the position of supplying the reducing gas is a part having a particularly high possibility of being oxidized with steam, for example, a part where the cell end portion of the steam supply portion 13 side can be made to have a sufficient reducing atmosphere.

Meanwhile, the oxidizing atmosphere on the oxygen electrode 11c side is increased by supplying an oxidizing gas to the supply gas containing steam as a main component, so that it becomes possible to reduce the reduction degradation of the electrode material and to keep the electrolytic property. Oxygen, air or the like can be used as the oxidizing gas, but its type is not particularly limited if the oxidizing atmosphere can be increased.

It is desirable that the position of supplying the oxidizing gas is a part having a particularly high possibility of being reduced with steam, for example, a part where the cell end portion of the steam supply portion 13 side can be made to have a sufficient oxidizing atmosphere.

According to this embodiment, a simple apparatus structure can be formed, and oxidation or reduction of both of the hydrogen electrode and the oxygen electrode is suppressed efficiently, and the electrodes can be made to have a long service life. In addition, since the apparatus structure is simple, it is also easy to reduce an influence due to the gas leak caused between the hydrogen electrode side atmosphere and the hydrogen electrode side atmosphere. Therefore, the steam electrolytic apparatus and method of the embodiment can electrolyze steam with high efficiency.

### Sixth Embodiment

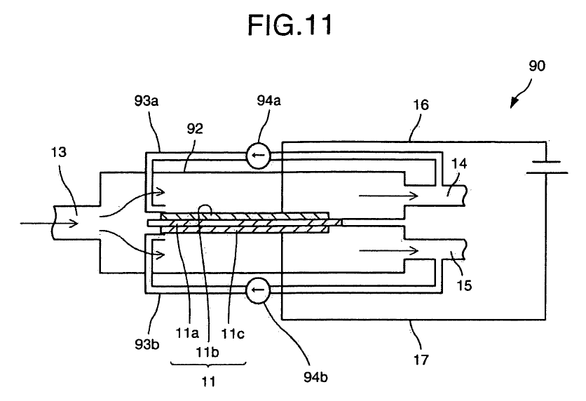

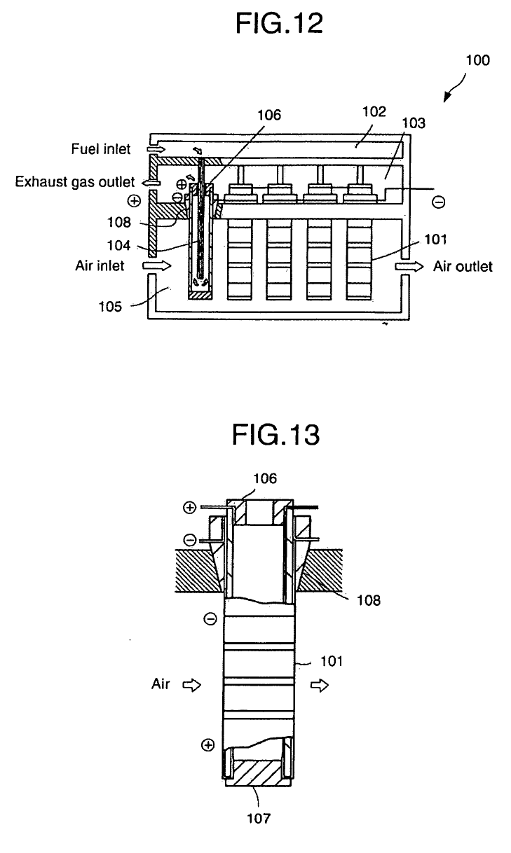

A sixth embodiment of the high-temperature steam electrolytic apparatus and method according to the present invention is described below with reference to FIG. 11. Component parts corresponding to those of the first embodiment are denoted by common reference numerals, and duplicate descriptions will be omitted. FIG. 11 shows the embodiment that the flat electrochemical cell is solely applied.

As shown in FIG. 11, a steam electrolytic apparatus 90 according to the sixth embodiment is mainly comprised of an electrochemical cell 11, a casing 92 for housing the electrochemical cell, a supply portion 13 for supplying a gas containing steam as a main component, a hydrogen gas discharge portion 14 for discharging the gas of a hydrogen electrode side atmosphere, an oxygen gas discharge portion 15 for discharging the gas of an oxygen electrode side atmosphere, a hydrogen electrode side current lead portion 16, an oxygen electrode side current lead portion 17, a hydrogen gas circulation supply portion 93a for circulating part of gas discharged from the hydrogen gas discharge portion to the hydrogen electrode side atmosphere, an oxygen gas circulation supply portion 93b for circulating partially the gas discharged from the oxygen gas discharge portion to the oxygen electrode side atmosphere, a blower 94a for circulating the hydrogen gas, and a blower 94b for circulating the oxygen gas.

This electrochemical cell 11 of this embodiment is same as in the first embodiment and configured to have the same structure as in the first embodiment except that the steam supply portion 13 side of the electrochemical cell 11 is provided with the hydrogen gas circulation supply portion 93a, the oxygen gas circulation supply portion 93b, the blower 94a for circulating the hydrogen gas, and the blower 94b for circulating the oxygen gas.

Specifically, in the hydrogen electrode 11b side of the electrochemical cell 11, the gas discharged from the hydrogen gas discharge portion 14 is circulated and supplied partially to make on the surface of the hydrogen electrode 11b a reducing atmosphere. And, in the oxygen electrode 11c side of the electrochemical cell 11, the gas discharged from the oxygen gas discharge portion 15 is circulated and supplied partially to make on the surface of the oxygen electrode 11c side an oxidizing atmosphere.

On the hydrogen electrode 11b side of the electrochemical cell 11, the gas discharged from the hydrogen gas discharge portion 14 is partially circulated and supplied to the supply gas containing steam as a main component, so that a hydrogen gas concentration is increased, and a reducing atmosphere is increased. Therefore, it becomes possible to reduce the oxidation degradation of the electrode material and to keep the electrolytic property. The gas discharged from the hydrogen gas discharge portion 14 has the hydrogen gas as a main component, so that it is not necessary to prepare another reducing gas for increasing the reducing atmosphere, and the electrolytic property of the hydrogen electrode 11b can be kept effectively at a low cost.

It is desirable that the position of supplying the generated hydrogen gas is a part having a particularly high possibility of being oxidized with steam, for example, a part where the cell end portion of the steam supply portion 13 side can be made to have a sufficient reducing atmosphere.

Meanwhile, an oxygen gas concentration on the oxygen electrode 11c side is increased and the oxidizing atmosphere is increased by circulating and supplying partially the gas discharged from the oxygen gas discharge portion 15 to the supply gas containing steam as a main component. Therefore, it becomes possible to reduce the reduction degradation of the electrode material and to keep the electrolytic property. The gas discharged from the oxygen gas discharge portion 15 has the oxygen gas as a main component, so that it is not necessary to prepare another supply gas to increase the oxidizing atmosphere by circulating the generated oxygen gas, and the electrolytic property of the oxygen electrode 11c can be kept effectively at a low cost.

It is desirable that the position of supplying the generated oxygen gas is a part having a particularly high possibility of being reduced with steam, for example, a part where the cell end portion of the steam supply portion 13 side can be made to have a sufficient oxidizing atmosphere.

1. A steam electrolytic apparatus, comprising:
an electrochemical cell composed of an electrolyte containing a solid oxide mainly, a hydrogen electrode and an oxygen electrode;
a steam supply portion for supplying the electrochemical cell with a gas containing steam as a main component;
a hydrogen gas discharge portion for discharging hydrogen generated at the hydrogen electrode by electrolysis of the steam; and
an oxygen gas discharge portion for discharging oxygen generated at the oxygen electrode by electrolysis of the steam,
wherein the oxygen electrode contains a reduction-resistant material.

2. A steam electrolytic apparatus, comprising:
an electrochemical cell composed of an electrolyte containing a solid oxide mainly, a hydrogen electrode and an oxygen electrode;
a steam supply portion for supplying the electrochemical cell with a gas containing steam as a main component;
a hydrogen gas discharge portion for discharging hydrogen generated at the hydrogen electrode by electrolysis of the steam; and
an oxygen gas discharge portion for discharging oxygen generated at the oxygen electrode by electrolysis of the steam,
wherein the hydrogen electrode contains an oxidation-resistant material.

3. A steam electrolytic apparatus, comprising:
an electrochemical cell composed of an electrolyte containing a solid oxide mainly, a hydrogen electrode and an oxygen electrode;
a steam supply portion for supplying the electrochemical cell with a gas containing steam as a main component;
a hydrogen gas discharge portion for discharging hydrogen generated at the hydrogen electrode by electrolysis of the steam; and
an oxygen gas discharge portion for discharging oxygen generated at the oxygen electrode by electrolysis of the steam,
wherein the hydrogen electrode contains an oxidation-resistant material, and the oxygen electrode contains a reduction-resistant material.

4. The steam electrolytic apparatus according to claim 3, wherein at least one of the oxidation-resistant material and the reduction-resistant material is contained in a part of the steam supply portion side.

5. The steam electrolytic apparatus according to claim 3, wherein at least one of the oxidation-resistant material and the reduction-resistant material is contained slantly so to decrease the contained concentration from the steam supply portion side toward the gas discharge portion side.

6. The steam electrolytic apparatus according to claim 3, wherein at least one of the hydrogen electrode and the oxygen electrode is formed by adding the oxidation-resistant material or the reduction-resistant material to the electrode material.

7. The steam electrolytic apparatus according to claim 3, wherein at least one of an adding and supplying means for a gas containing a reducing gas on the hydrogen electrode side and an adding and supplying means for a gas containing an oxidizing gas on the oxygen electrode side is provided.

8. The steam electrolytic apparatus according to claim 7, wherein the reducing gas is a gas flown through the hydrogen electrode and discharged from a hydrogen gas discharge portion, the oxidizing gas is a gas flown through the oxygen electrode and discharged from an oxygen gas discharge portion, and a circulation supply means for adding and supplying by circulating at least one of the reducing gas and the oxidizing gas is provided.

9. A steam electrolytic method, comprising:
supplying a raw material gas;
generating a hydrogen gas and an oxygen gas by contacting the supplied raw material gas to an electrochemical cell which is composed of an electrolyte containing a solid oxide mainly, a hydrogen electrode and an oxygen electrode to electrolyze steam contained in the raw material gas; and
discharging separately the hydrogen gas and the oxygen gas without causing a leakage of them,
wherein the hydrogen electrode contains an oxidation-resistant material, and the oxygen electrode contains a reduction-resistant material.
